(19) United States
(12) Patent Application Publication
(10) Pub. No.: US 2018/0308229 A1
(43) Pub. Date: Oct. 25, 2018

(54) METHOD AND INFORMATION SYSTEM FOR DETECTING AT LEAST ONE PLANT PLANTED ON A FIELD

(71) Applicant: Robert Bosch GmbH, Stuttgart (DE)

(72) Inventors: Achim Winkler, Ditzingen (DE); Dejan Pangercic, Stuttgart (DE); Gabriel Gaessler, Renningen (DE); Markus Hoeferlin, Simmozheim (DE); Roland Leidenfrost, Beilstein (DE); Steffen Fuchs, Leonberg (DE); Tobias Dipper, Fellbach (DE); Tobias Mugele, Rutesheim (DE)

(21) Appl. No.: 15/771,012

(22) PCT Filed: Oct. 7, 2016
(86) PCT No.: PCT/EP2016/073939

§ 371 Date: Apr. 25, 2018

(30) Foreign Application Priority Data
Oct. 28, 2015 (DE) 10 2015 221 085.5

(51) Int. Cl. G06T 7/00; G06K 9/00; G06T 7/70; G06T 7/90

(52) U.S. Cl. CPC G06T 7/0002; G06K 9/00657; G06T 7/70; G06T 7/90; G06T 2207/10024; G06T 2207/30188; G06T 2207/30242; G06T 2207/10048; G06K 9/00791

(57) ABSTRACT

A method for detecting at least one plant planted on a field, including: detecting a plant with an optical and/or infrared detection unit to obtain a piece of plant image information and detecting a piece of position information, which represents a geographic position, at which the plant grows in the field. Furthermore, the method includes identifying the plant using the piece of plant image information, to obtain a piece of plant information, which represents the presence of the plant. Finally, the method includes storing the piece of plant information and the geographic position in a plant dataset, to detect the plant planted on the field.

### FIELD OF THE INVENTION

The present invention is directed to a method for detecting at least one plant planted on a field or to an information system according to the definition of the species in the independent claims. The present invention is also a related computer program.

### BACKGROUND INFORMATION

In agriculture, standardized methods are extensively applied for assessing the growing or treatment progress during the growing of new varieties and during the optimization of the seed quality. These methods are used in comprehensive experimental series, which include multiple repetitions at various locations.

Experimental series (so-called series) which take place in the field and substantially reflect the actual growing situation have the highest informative value for growers. Therefore, multiple large-sized beds, which are divided up into parcels, are laid out for these field experiments.

In the greater part of the field experiments, rating methods are used, in which the features to be assessed of a plant (germination, shoots, plant height, leaf size, flower, ripeness, etc.) are assigned a rating grade (numeric value from 1 to 9) according to the development stage. The features to be observed are dependent on the type of crop.

The assignment of the rating grades is carried out by human observers. The results are typically noted on paper in the field and transferred into a PC in a further processing step. In rare cases, handheld computers (tablets) having specific input masks are presently used for rating specific crops and features.

The data detected by persons in the field experiment according to the rating schema are analyzed thereafter. The analysis is typically a manual method, in which the partial results are summarized in tables and subsequently analyzed with the aid of statistical methods.

### SUMMARY OF THE INVENTION

Against this background, with the approach presented here, a method for detecting at least one plant planted on a field, furthermore an information system which uses this method, and finally a corresponding computer program according to the main claims are presented here. Advantageous refinements of and improvements on the device specified in the independent claim are possible by way of the measures indicated in the dependent claims.

The approach presented here provides a method for detecting at least one plant planted on a field, the method including the following steps:
detecting a plant with the aid of an optical and/or infrared detection unit to obtain a piece of plant image information, and detecting a piece of position information, which represents a geographic position at which the plant grows in the field;
identifying the plant using the piece of plant image information to obtain a piece of plant information which represents the presence of the plant; and
storing the piece of plant information and the piece of position information in a plant dataset to detect the plants planted on the field.

A field may be understood in the present case to be an acreage for plants or also a parcel of such a field. A plant may be understood, for example, to be a crop plant, the fruit of which is used agriculturally, for example, as a food, animal feed, or as an energy plant. An optical detection unit may be understood, for example, to be a camera. A geographic position at which the plant grows in the field may be understood, for example, to be a piece of information which represents the position of the plant as world coordinates or reflects the location of the plant in relation to a corner coordinate of the field. A piece of plant image information may be understood as an image or a plant parameter, which reflects the features of the plant which may be optically detected or the features of the plant which may be detected with the aid of infrared radiation. In this case, the piece of plant image information may also contain pieces of information which are obtained by a treatment or processing of the image of the plant detected by the optical camera and/or the infrared sensor. Identification of the plant may be understood, for example, as the determination of the presence of the plant at the geographic position and/or a determination of a shape, size, species, number of leaves, leaf structure, number of buds, bud structure, or other biological features, which makes a plant differentiable from other plants. In this case, for example, the determination of a boundary of a plant in relation to another plant may also take place. A piece of plant information may be understood in the present case as a parameter or a piece of information, for example, the above-mentioned shape, size, species, number of leaves, leaf structure, number of buds, bud structure, or the like, which enables a differentiation of the plant from another plant. However, the parameter may also merely provide a piece of information about the presence of the plant itself at the geographic position. A plant dataset may be understood as a dataset or an information unit which is stored or is to be stored in a memory, in which the piece of plant information is or will be stored with an associated geographic position of the plant.

The approach provided here is based on the finding that using a detection unit, the detection of the plant of a specific geographic position may take place very rapidly and, due to the avoidance of a human classification, reproducibly. In this case, the fact is furthermore utilized that due to the storage of the piece of plant information and the geographic position in the plant dataset, a plant dataset which is very easily readable by machine is generated at the same time, which may be further evaluated very easily for a subsequent analysis. Due to the association of a geographic position with the plant and the piece of plant information, it is furthermore ensured that in repeated cycles of the detection of the plant, the same plant may always be detected, so that the development state of this plant may be tracked in a chronologically unambiguous way.

The approach provided here offers the advantage that the assessment of the plant growth of the plant may be carried out very rapidly automatically. This is helpful in particular if the growth of a large number of plants is to be monitored, as is required, for example, in seed research. In this case, for example, different growth conditions are created in different subareas of the field, for example, by deploying different types and quantities of fertilizers, this knowledge of the growth and environmental conditions in conjunction with the plant information and the geographic position offering an inference about the effect of these growth and environmental conditions on the course of development of the plant at the corresponding geographic position. The approach provided here thus enables a significant improvement in the assessment of the development stages of plants growing on the field by automated detection of the plants and automatic storage of the pieces of plant information together with the piece of geographic information in the plant dataset.

According to one specific embodiment of the approach presented here, in the step of detection, the plant may be detected from a plurality of viewing directions and/or using an exposure time of less than one-half of a second, in particular the plant being detected using an exposure time of less than one-tenth of a second. Such a specific embodiment of the approach presented here offers the advantage of generating a very precise and an error-free image of the plant, to be able to largely exclude interfering effects during the recording of the image, for example, due to wind or shadowing of individual plant parts.

Furthermore, one specific embodiment of the approach presented here is advantageous, in which, in the step of detection, the piece of plant image information is detected using a piece of previously input plant spacing information, which represents a spacing of plants in the field. Such a piece of previously input plant spacing information may be, for example, a piece of information in which spacing grids of individual plants, which are especially to be examined, were originally planted during the lay out of the field. Such a specific embodiment of the approach provided here offers the advantage that a preselection of plants which are actually to be examined or detected in greater detail may be carried out, with the result that substantial effort may sometimes be saved in the recording or identification of plants.

One specific embodiment of the approach presented here is technically very simple and reliable, in which, in the step of identification, the plant is identified using a color content of a plant image from the piece of plant image information, in particular using a green color content of the plant image from the piece of plant image information and/or an infrared content of the plant image of the piece of plant image information. Such a specific embodiment of the approach provided here offers the advantage of using already mature algorithms of image processing to be able to identify individual parts or entire plants in the piece of plant image information.

According to another specific embodiment of the approach provided here, in the step of identification, a determination of a piece of growth information may also take place as partial information of the piece of plant information, which represents a development state and/or a health state of the plant, in the step of storage, the piece of growth information being stored as partial information of the piece of plant information in the plant dataset. Such a piece of growth information may be, for example, information about the species, height, shape, or the number of leaves, buds, branches, or the like, or information about a structure of the plant itself or parts of the plant. Such a specific embodiment of the approach provided here offers the additional advantage that not only the presence of the plant, but rather one or multiple further parameter(s) which are relevant for the assessment of the development state and/or the health state of the plant also may already be recorded or stored in the plant dataset.

Furthermore, a specific embodiment of the approach provided here is particularly advantageous, in which, in the step of identification, a detection of a species of the plant takes place, to obtain a piece of plant information, in particular a differentiation of the species of the plant from a species of another plant taking place upon the detection. A species of a plant may be understood in the present case as a genus of the plant. Such a specific embodiment of the approach provided here offers the advantage of being able to carry out a differentiation of a useful or crop plant from a weed, which does not have to be observed further, for example, for the examination of the development state of the plant. In this way, for example, it may also be established that at the geographic position at which, for example, a useful plant was planted at an earlier time but succumbed to drought or being eaten by an animal, a weed plant (not to be considered further) has grown. Such a piece of information, that a weed plant is now growing at the present geographic position, may also be stored as part of the piece of plant information in the plant dataset.

One specific embodiment of the approach provided here is particularly advantageous for assessing the development state of a plurality of plants, in which in the step of detection, at least one further plant is detected with the aid of an optical and/or infrared detection unit, to obtain at least one further piece of plant image information, and at least one further geographic position is detected, at which the further plant grows in the field. In the step of identification, the further plant is identified using the further piece of plant image information, to obtain a further piece of plant information which represents the presence of the further plant. In the step of storage, the further piece of plant information and the further geographic position are stored in the plant dataset. Such a specific embodiment of the approach provided here offers the advantage of being able to carry out a detection of a plurality, in particular a multiplicity of plants in a highly automated and therefore rapid and reliable manner. In this way, it is possible to obtain very precise pieces of information about the development state of the plants on the field.

One specific embodiment of the approach presented here is particularly advantageous, which includes a step of counting plants cultivated on the field while using the piece of plant information and the further piece of plant information from the plant dataset. Such a specific embodiment of the approach presented here offers the advantage of rapid, reliable, and unambiguous counting of the plants cultivated on the field.

Furthermore, one specific embodiment of the approach provided here is advantageous, in which the steps of detection, identification, and storage are repeatedly carried out at least once, in particular are repeatedly carried out cyclically, in particular a time parameter being stored in addition in each step of the storage, which represents an ascertainment point in time of the piece of plant information contained in the stored plant dataset. Such a specific embodiment of the approach provided here offers the advantage of forming a very precise history about the development state of the plant.

Furthermore, one specific embodiment of the approach provided here is advantageous in which, in the step of detection, the piece of plant image information is detected using a piece of information of a piece of plant image information which was recorded chronologically previously or is expected, and/or, in the step of identification, the plant is identified using a piece of identification information which was recorded chronologically previously. Such a piece of information of a piece of plant image information or identification information which was recorded chronologically previously may be, for example, a recognition algorithm for the plant, which was optimized in a training cycle carried out previously, especially for detecting the plant or the features of the plant. In this way, the detection or identification may be simplified, since the piece of plant image information has to be compared only to a piece of reference information or a reference image and in this way significantly less numerical or circuitry-wise expenditure is necessary for ascertaining the piece of plant information.

To be able to recognize damage or soiling of the detection unit, for example, using a simple arrangement, in the step of detection, a plausibility check of the piece of plant image information may be carried out using a piece of plausibility information from a piece of plant image information which was recorded chronologically previously, to ascertain a functional capability of the detection unit. Such a plant image recorded chronologically previously may be, for example, a piece of plant image information that was recorded in a preceding execution of one specific embodiment of the method for detection provided here. Such an approach offers the advantage of already being able to detect a technical malfunction of the detection unit using the simple arrangement, so that no faulty data are stored in the plant dataset and early troubleshooting at the detection unit is possible.

One specific embodiment of the approach provided here is particularly advantageous, in which in the step of detection, a detection unit situated on a vehicle and/or on an aircraft is used to detect the plant. Such a specific embodiment offers the advantage of rapid, unambiguous, and reproducible detection of a large number of plants on the field.

This method may be implemented, for example, in software or hardware or in a mixed form of software and hardware, for example, in a control device.

The approach presented here furthermore provides an information system, which is configured to carry out, control, and implement the steps of a variant of a method presented here in corresponding units.

The object underlying the present invention may also be achieved rapidly and efficiently by this embodiment variant of the present invention in the form of a device.

For this purpose, the information system may include at least one processing unit for processing signals or data, at least one memory unit for storing signals or data, at least one interface to a sensor or an actuator for reading in sensor signals from the sensor or for outputting data or control signals to the actuator, and/or at least one communication interface for reading in or outputting data, which are embedded in a communication protocol. The processing unit may be, for example, a signal processor, a microcontroller, or the like, where the memory unit may be a flash memory, an EPROM, or a magnetic memory unit. The communication interface may be configured to read in or output data in a wireless and/or wired manner, a communication interface, which may read in or output wired data, being able to read in these data, for example, electrically or optically from a corresponding data transmission line or output them into a corresponding data transmission line.

An information system may be understood in the present case to be an electrical device, which processes sensor signals and outputs control and/or data signals as a function thereof. The device may include an interface, which may be in the form of hardware and/or software. In the case of a hardware configuration, the interfaces may be, for example, part of a so-called system ASIC, which contains greatly varying functions of the device. However, it is also possible that the interfaces are separate, integrated circuits or are made at least partially of discrete components. In the case of a software configuration, the interfaces may be software modules which are provided in addition to other software modules on a microcontroller, for example.

In one advantageous embodiment, a control of an electronic recording of the plant dataset is carried out by the information system. For this purpose, the information system may access, for example, sensor signals such as the image data of the detection unit and pieces of geographic position information read in via an interface (for example, from a satellite-based positioning system). The control takes place via actuators, for example, a recording head for an electromagnetic recording of the piece of plant information and the piece of geographic position information in the plant dataset or in a microelectronic memory.

A computer program product or computer program is also advantageous, having program code which may be stored on a machine-readable carrier or storage medium such as a semiconductor memory, a hard drive memory, or an optical memory and may be used to carry out, implement, and/or control the steps of the method according to one of the above-described specific embodiments, in particular if the program product or program is executed on a computer or a device.

Exemplary embodiments of the present invention are illustrated in the drawings and explained in greater detail in the following description.

In the following description of advantageous exemplary embodiments of the present invention, identical or similar reference numerals are used for the elements which are shown in the various figures and act similarly, a repeated description of these elements being omitted.

### BRIEF DESCRIPTION OF THE DRAWINGS

FIG. 1 shows a representation of a use of an exemplary embodiment of an information system for detecting at least one plant planted on a field.

FIG. 2 shows a schematic representation of an exemplary embodiment of the method having a functionality of an automated high throughput plant counting and measurement in the field.

FIG. 3 shows a flow chart of a method according to one exemplary embodiment.

### DETAILED DESCRIPTION

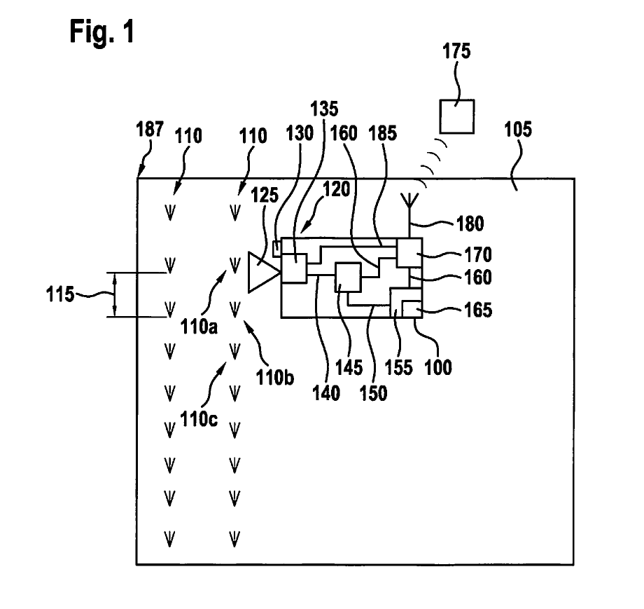

FIG. 1 shows a representation of a use of an exemplary embodiment of an information system 100 for detecting at least one plant 110 cultivated on a field 105. Plants 110 may be situated in columns, as shown in the left area in FIG. 1, and may be spaced apart from one another in each case, for example, in a plant spacing 115. The geographic position of individual plants 110 may already have been ascertained during the layout of field 105 and stored in a corresponding file. To be able to recognize the plants cultivated on field 105, information system 100 has a detection unit 120 for detecting a (single) plant 110a.

Detection unit 120 may include, for example, an optical camera 125 and/or an infrared sensor 130 (also referred to as an infrared camera), which create an optical image and/or an infrared image of plant 110a. It is also conceivable that detection unit 120 includes a filter unit 135, to extract a color content, for example, the green color content of the image detected by optical camera 125. The optical image of camera 125, an infrared image of infrared sensor 130, and/or an image derived from the optical image of camera 125 and/or the infrared image of infrared sensor 130 may be output as plant image information 140 by detection unit 120.

The piece of plant image information 140 is read in by a unit 145 for identification and the piece of plant information 150 is ascertained by applying corresponding algorithms. The piece of plant information 150 represents the presence of plant 110a. For example, unit 145 for identification may use an image processing algorithm for this purpose, in which, on the basis of color contents, for example, a green content in specific image areas, an inference may be drawn that a leaf or another component of plant 110a has to be depicted in these affected areas. Additionally or alternatively, an edge detection algorithm may also be used, to detect the outlines of plant 110a and in this way to detect a spatial delimitation of plant 110a from one or multiple adjacent plants.

Finally, the piece of plant information 150 is transferred to a memory unit 155, in which the piece of plant information 150 is stored together with a piece of position information 160, which represents a geographic position, in a plant dataset 165. The piece of position information 160 is provided in this case by a position detection unit 170, which provides the piece of position information 160, for example, using a satellite-based positioning system 175, for example, the GPS system. This piece of positioning information 160 relates to the present geographic position of which detection unit 120 or a subunit of detection unit 120 has produced an image. In the case of a spatially larger extension of information system 100, an offset correction may possibly also take place in position detection unit 170, which takes into account a spacing of an antenna 180 of position detection unit 170 from the image recording area of detection unit 120.

It is furthermore conceivable that a file is also stored in position detection unit 170, which contains spacing or at which geographic positions plants 110 were planted, so that also, for example, a trigger signal 185 is sent by position detection unit 170 to detection unit 120 when a geographic position is reached at which a plant 110a is to be expected. In this way, a numerical expenditure for the ascertainment or analysis of the image or images recorded by detection unit 120 may be reduced, since images are only recorded at specific points in time by detection unit 120, which are subsequently analyzed in unit 135 and unit 145 for identification. Furthermore, it is conceivable that position detection unit 170 also only detects a relative position of information system 100 in relation to a corner coordinate 187 of field 105 and in this way ascertains the relative position of plant 110a. This relative position of the plant in relation to corner coordinate 187 as the geographic position or as piece of position information 160 is also sufficient in this case to be able to draw relevant pieces of information from the plant dataset with respect to the particular plants such as plant 110a for the subsequent analysis of the pieces of information. Furthermore, it is also conceivable that piece of position information 160 is supplied as a signal to unit 145 for identification. In this case, unit 145 for identification may already use the knowledge of the present geographic position from piece of position information 160, for example, from preceding detection cycles, to determine a specific species of the plant, size of the plant, or the like by comparison of the present piece of plant image information to the previously identified pieces of plant information contained in plant dataset 165. In this way, an expenditure for identifying the plant may be significantly reduced, since some pieces of information to be expected about the species of plant 110a, size of the plant, or the like may already be presumed.

It is furthermore conceivable that upon the identification of plant 110a, a piece of growth information is moreover also ascertained from the piece of plant image information 140, which represents, for example, the size of plant 110a, a number of leaves of plant 110a, a number of buds of plant 110a, a structure of the leaves of plant 110a, or other botanical features of plant 110a, from which an inference may be drawn about the development state and/or the health state of plant 110a. This growth information may also be transferred as part of plant information 150 to memory unit 155 and stored in plant dataset 165. In this way, not only may a count of individual plants 110 on field 105 be carried out, but rather also a plant dataset 165 which may be automatically processed very well may be prepared in a very technically simple manner, which permits a precise analysis of the growth of plants 110 growing on field 105.

For this purpose, it is advantageous if not only one plant 110a is detected using the above-described exemplary embodiment of information system 100, but rather if also further plants such as plants 110b and 110c, for example, are also detected similarly to the above-described procedure and a corresponding combination of a piece of plant information 150 with a piece of position information 160 is stored in each case for each of plants 110b and 110c in plant dataset 165.

It is particularly advantageous if, for example, according to the above-described procedure, information system 100 is used to determine a history of the growth of plants 110 cultivated on field 105. For this purpose, information system 100 may be used at time intervals, in particular cyclically at intervals of days, weeks, and/or months, to detect plants 110a, 110b, and/or 110c cultivated on field 105. In this case, after each detection of a plant 110, a corresponding combination of the piece of plant information 150 with the particular piece of position information 160 may be stored in plant dataset 165, in addition a piece of time information being stored with this preceding combination of plant information 150 and position information 160, which specifies a point in time, for example, a date and an hour, at which a piece of plant image information of corresponding plant 110a, 110b, and/or 110c was detected by detection unit 120.

The detection of plants 110 planted on field 105 is particularly simple if information system 100 is mounted, for example, on or at a vehicle or aircraft (not shown in FIG. 1). This has the result that without greater personnel expenditure, a detection of plants 110 planted on field 105 may be carried out rapidly and reliably and therefore a large and automatically analyzable plant dataset 165 may be built up very rapidly using a technical arrangement.

Compared to the above-described procedure, in contrast, the described manual rating methods are very subjectively applied, because the results of the ratings arise from observation. Various observers may sometimes differ strongly from one another in their assessment. In addition, the classification into only nine qualitatively evaluated steps may represent a restriction in the objective assessment of approximately equivalent candidates in the genetic selection.

The approach provided here is oriented to the automation of parts of the above-described field experiments. The mentioned disadvantages are remedied and at the same time a higher throughput (field experiments per unit of time and personnel use) is achieved by automated data acquisition.

Further improvement aspects result because of the substantially higher data storage capacity of the measuring computer in comparison to the above-described manual recording method. The computer-assisted recording and management of the measuring data is possible down to the individual plant level and takes place directly on the field. In this context, the history of the physiological development of each individual measured plant may be taken into consideration in the assessment of growing candidates, varieties, seed qualities, or use of plant protection products.

The approach provided here may be used in particular for the assessment of the field germination stage as an important development phase of crop plants.

In the field germination stage, the task is the detection with respect to numbers and quotas of the growing plants. The field germination quota is in particular an essential quality feature (in accordance with variety and seed) in the case of rising seed quality (linked to high costs for seed) and precise spreading using single seed sowing machines. The field germination count in the manual rating method is presently a quota count. Accordingly, one field germination quota per parcel is detected. An association with the specific individual plant is not possible in this way, because of which analysis errors are possible even in the event of correct counting (for example, seedlings also disappear after emergence because of being eaten or other external circumstances). The approach presented here overcomes this disadvantage because it enables the (re-) detection, counting, and association with each individual plant in the population multiple times with respect to a unique position. Beyond the field germination phase, a history of the development of each plant at its associated position may be ascertained.

In this stage, inferences about the development progress of the individual plant in relation to the sowing and/or field germination date may be drawn from the actual leaf area. One aspect of the approach presented here may therefore be seen in a possibility for reproducibly configured automatic detection of the leaf parameters of each individual young plant.

The disadvantages of the manual rating method are overcome using the high throughput measurement in the field under consideration of each individual plant as presented here.

The correct plant counting and recording of a position-related history has great significance for the following goals:
In the assessment of the seed quality in field experiments (seed is offered in various qualities and optimized for different location conditions). One quality feature is the germination quota promised by the producer. A further quality-forming feature is the field germination time. A simultaneous germination of the seeds may result in a homogeneous population. This is significant for plant care, for certain yield parameters, and for the harvest. Homogeneous fields may be cultivated better (mechanically).
In the assessment of growing progress in field experiments. Growing goals are, for example, stress tolerances, resistances and properties specific to types of fruit. Yield is an integral growing goal, which is achieved in conjunction with multiple specific partial goals.
In the variety testing by institutional organizations. The varieties developed by seed producers are tested and monitored by these institutions with respect to their features and properties. By way of the improved measuring and analysis technology, the tests may be performed more rapidly, and with higher accuracy and lower personnel expenditure.
In the development and application of plant protection products (PPP). The function of the plant counting and recording of a position-related history may be used in conjunction with the employment of PPP for monitoring and refinement of the performance of PPP.
For the continuous improvement of the knowledge about the suitability of the varieties and seed qualities for the different locations worldwide (areas of use). For this purpose, the methods according to the present invention may also be used in daily agricultural operation. The data obtained during the cultivation on field germination and plant development are, after linkage to climatic data and pieces of weather information in databases of the seed producers, important indicators of the regular suitability test and improvement of the location recommendations. Due to progressing climatic changes, this signifies an important advantage for the seed producers and farmers.

The introduced approach solves the disadvantages of the known approach and expands the applicability by way of the following additional advantages:

a.) Elimination of subjective influences during counting and/or measurement of plants by persons

b.) Nondestructive high throughput leaf area and height measurement of the plants having the following properties:
the individual leaf areas of young plants and seedlings at the individual plant level
total leaf area detection of individual plants

c.) Detection of the field germination of each individual plant and association with a unique position (for example, based on RTK GPS position, triangulation, trilateration, odometry, etc.)

d.) Re-detection of the individual plant at the specified position and documentation of the physiological development thereof on the basis of the measuring cycles proceeding from sowing and germination dates

e.) Detection of the loss of individual plants by being eaten, drought, etc.

f.) High degree of automation of the measurements by use of the metrology on vehicles/aircraft including integrated autonomous locating and navigation

g.) High degree of automation of the measuring procedures by computer-assisted recording and analysis of large quantities of data

h.) The measurement is carried out by photogrammetric detection for the brief duration of a single exposure. This precludes the influence of external factors, for example, wind.

i.) If multiple image recordings are made in succession (for example, while the measuring device is moved over the population), images of the corresponding plants are thus obtained in the image detail from various starting positions. The analysis of the obtained images enables an improvement of the measuring results.

j.) With the aid of classification methods, the data management software differentiates between examined crop plants and weeds. This classification is additionally assisted by a priori knowledge (for example, alignment, row spacing, and plant spacing). Due to the cyclically occurring measurements and classifications, a refinement results of the measuring and classification results, for example, by transformation (in the method of alignment) of the metrologically obtained position grid of the plants.

k.) Due to the history of each plant included in the data management at its previous position, a correction and/or improvement of the data set is also possible retroactively (for example, incorrect assignments may be corrected later).

l.) The data processing may take place both online (during the running data detection on the field) and offline (in the follow-up to the data recording). The online analysis moreover enables plausibility checks of the obtained measuring data, to minimize errors and external influences and/or eliminate them on site.

m.) The use of suitable methods for data compression and reduction enables the (longer-term) storage of measuring and analysis data on the device or a (wireless) transmission to a cloud-based storage system.

n.) The data management moreover permits the collection and analysis of data which were recorded by devices or methods of third-party providers. Corresponding interfaces for data exchange are a requirement.

o.) Further findings (for example, about pest infestation, diseases, influence of external factors such as weather, water, drought) may be obtained from the obtained data. The relationship to the influencing factors is of decisive significance for the assessment of the growing and/or seed treatment or plant protection measures.

p.) The (partially) automatic functions according to the present invention contribute to an overall examination of the plants in the population (i.e., as a result the user obtains a continuous overall image of the plants in the population during various development phases).

q.) The present invention takes into consideration a plausibility check on the basis of a (partial) online analysis of the measured data. It is thus ensured that malfunctions in the measuring device (for example, a soiled camera lens) are already detected at the beginning of the measurement and recording of the data. In this way, it is ensured that no unsuccessful experiments are carried out and resources are preserved.

The approach presented here includes two important elements:

a. A metrological part, which implements the functions of plant counting and position association.

b. A data management part, which, for example, collects, archives, and analyzes comparatively large quantities of data and/or processes them as meaningful reports and is used for planning the measuring actions. The detected measuring data may be processed directly on the measuring device depending on the computing power and data connection or may be transmitted to a central server. Alternatively, storage on suitable data carriers is also possible, which may be read out for the measurement as a follow-up.

A suitable mobile approach uses the measuring device (i.e., information system 100 here) as a carrier platform for carrying out the field experiments. This mobile approach may involve a (semi-) autonomous vehicle, a manually operated or motorized vehicle, as an attachment for tractors, as an aircraft (for example, as a drone), or in the simplest embodiment in portable form (for human or animal).

For an optimum construction of measuring device 100, multiple parallel measuring units 120 may optionally be integrated into one structure, so as to meaningfully use existing lanes or other conditions of the field structure.

In the context of a further parallelization of tasks, the distribution of the measurements to multiple mobile devices is also possible (for example, according to the swarm or master-slave principles). The measuring device presented here as information system 100 has a position and orientation sensor 170 (for example, RTK GPS), optionally supplemented by an orientation sensor (for example, an inertial measurement unit IMU), optionally supplemented by odometrically obtained pieces of position information.

Moreover, it has one or multiple cameras 125 including RGB and IR information channels and a suitable lighting unit for the wavelength ranges required for this purpose. An optional shading unit of the image areas ensures that the interfering influence of external light and shadows is minimized. The shading unit is constructed in such a way that it does not touch the plants as it traverses them.

In detail, the following exemplary sequences and functions are integrated in measuring and analysis device 100:

1. The boundaries and dimensions of the entire experimental plot, the location and alignment of the parcels and field paths, and the trajectories which result from the seed rows are given. These data are geo-referenced and have been detected in a preprocessing step (for example, upon the creation of the experimental plots or during the sowing). These geo-data are reported to measuring device 100 (information system 100 here).

2. The concrete experiment planning (here, for example, allocation of the parcels and the association thereof with experimental objects and series) is also read in before the beginning of the measurements into measuring device 100 (experiment description).

3. Measuring device 100 is guided row by row (for example, in the drill direction) across the experimental plots (i.e., field 105 here). This procedure may take place multiple times.

4. During the screening procedure (e.g., traverse), cameras 125 and/or 130 of detection unit 120 installed in measuring device 100 are controlled in accordance with the known boundaries of the parcels and record data as plant image information 140. It is particularly notable that during the duration of the traverse, one or multiple plants 110a and 110b are detected in the image detail. Due to the one-shot image recording technique, multiple recordings of the same plant 110a and 110b are made sequentially (image sequencing). This method permits the influences due to changing wind and light conditions and overlaps and noise in the image to be reduced to a minimum.

5. The image data recorded by cameras 125 and 130 under given lighting circumstances include, for example, a.) RGB images and b.) infrared images. Cameras 125 and 130 are calibrated (for example, to compute the height assignment from the images).

6. The images detected by cameras 125 and 130 are registered with one another, for example, to subsequently be able to compute an NDVI (normalized difference vegetation index, which is formed from reflection values in the near infrared and visible red wavelength range of the light spectrum).

7. The separation of biomass and ground in the image is carried out on the basis of the predetermined NDVI value, which therefore results in biomass masks (reduced image data with clusters of green content which represent individual plants with high probability).

8. Positions in the global coordinate system (for example, RTK GPS positions) are associated with the biomass masks. Multiple types of fused sensor data come to bear here (for example, orientation of the measuring device, transformation between camera position and position sensors).

9. The classification methods are applied to the recognized green clusters on the basis of the geo-referenced biomass masks. In the case of a subsequent traverse, the biomass masks are re-identified on the basis of their global position data. The classification may take place online (during the ongoing measurements) or offline (in the follow-up). The classifiers used have been trained for this purpose before carrying out the measurements. For this purpose, data on experimental plots have been collected and manually examined and “labeled” (annotated). The trainer differentiates between crop plants and weeds in this procedure. The classification is based on multiple parameters, for example, geometric features of the biomass masks (such as shape or size) and statistical features (such as numbers of pixels of specific colors and their distribution on the basis of intensity values).

10. The classification takes place on the basis of all image data which were recorded during the measurements (multiple images during the traverse, over multiple traverses). All classification results are taken into account and contribute to an overall result on the basis of a majority voting evaluation method. This result is updated with the present datum in each case and may be used to correct misclassifications in the past. Overall, the probability of a correct classification is increased by the applied method.

11. In addition to the classification as described above, a priori knowledge about the location of the plant row and about the spacing (for example, plant spacing) are incorporated into the final decision of whether it is a crop plant or a weed.

12. A computation of suitable features which contribute to the experimental results (for example, estimation of the leaf area, detection of the field germination, or also the loss of crop plants) is carried out on the basis of the final biomass masks classified as crop plants.

13. The data are stored after recording and analysis, for example, in a cloud-based environment and kept ready for visualization and further analysis on terminals. Analyses may have various tabular, graphic, and written forms and contain all measured parameters and parameters derived therefrom (for example, illustration to scale of the plants in their parcels as a top view, weed population in the experimental field, etc.).

14. The data, which were collected in various experimental series at different locations and over multiple years, form a very large quantity which are usefully stored automatically by decentralized measuring devices, which are coupled via cloud services, for example, in a suitable database structure. For this purpose, the data are to be reduced to the amount which is necessary and actually relevant or are also additionally to be compressed. Suitable algorithms for search and filtering permit analyses related to individual plants, parcels, series, experiments, and locations and also further analyses encompassing varieties and crops.

Furthermore, the traceability and history of an individual plant from cultivation to the consumer are mentioned as an example here. This also relates to data which the database has obtained outside the measuring device, for example, geo-related pieces of information on the weather, precipitation, soil values (temperature, conductivity, fertilizer concentration, etc.).

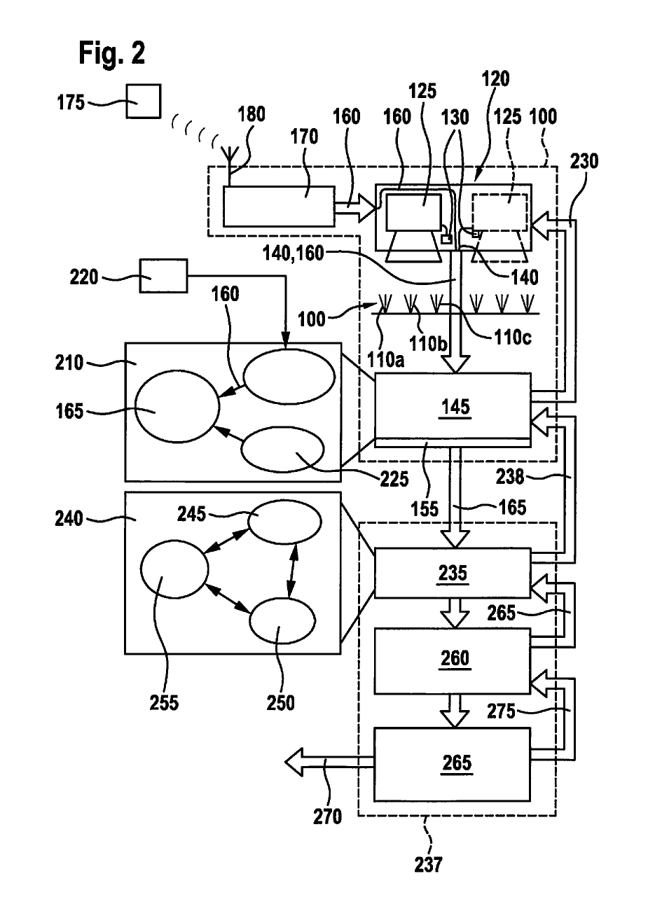

FIG. 2 shows a schematic representation of an exemplary embodiment of the method including a function of automated high throughput plant counting and measurement in the field. In this case, in a carrier platform such as information system 100, a piece of position information 160 representing the geographic position is initially read in via position detection unit 170. This piece of position information 160 may be detected, for example, via an interface 180 to a satellite-assisted positioning system 175, so that, for example, GPS data are detected and geographic position 160 of information system 100 may be ascertained in this way. It is furthermore conceivable that the piece of position information 160 is detected from a memory in conjunction with odometrically detected movement data of information system 100. Furthermore, carrier platform or information system 100 includes at least one detection unit 120 for detecting a plant 110a and 110b and 110c with the aid of optical camera 125 and/or infrared camera 130, to obtain a piece of plant image information 140 or an image derived therefrom. Detection unit 120 may include, for example, one or multiple sensor system(s) such as cameras 125 and 130, which may be configured, for example, as a cost-effective optical camera, which detect or detects images of plants 110a and 110b and transmits these images as plant image information 140 or information derived therefrom to unit 145 for identification. In unit 145 for identification, for example, a data extraction and/or a data fusion of piece of plant image information 140 and/or the information derived therefrom with the piece of position information 160 may take place.

As shown in greater detail in area 210 of FIG. 2, for example, an association 215 of the geographic position (extractable from position information 160) with plant 110a may be carried out. For this purpose, for example, the geographic position known from position detection unit 170 and/or from a memory 220 during the laying out of field 105 (for example, using GPS data) of plant 110a may be used and/or may be used for the plausibility check. Furthermore, a concrete detection or identification 220 of plant 110a in the form of piece of plant image information 140 or the information derived therefrom may take place, so that, for example, these pieces of information may be stored in plant dataset 165. A piece of information about extracted features of plant 110a, for example, a number of leaves, a leaf structure, or the like of particular plant 110a may also be stored in plant dataset 165 as part of plant image information 140 or the information derived therefrom. Finally, the piece of plant information 145 is stored together with the particular corresponding piece of position information 160 in plant dataset 165 in memory unit 155.

In addition, it is conceivable that it is recognized in memory unit 155 or a corresponding control unit (not shown in FIG. 2), that, for example, a light exposure of the area detected by camera(s) 125 and/or 130 is too weak, so that an exposure unit (not shown) (for example, as a subunit of unit 120 for detection) is activated to change, in particular to increase the brightness in the area detected by camera(s) 125 and/or 130. Such an activation signal 230 may be output, for example, by unit 145 for identification and/or memory unit 155 or the control unit (not shown in FIG. 2) to unit 120 for detection.

Plant dataset 165 may be output, for example, to a processing unit 235, which is either part of information system 100 or, for example, is also situated in a central computer 237, as is shown by way of example in FIG. 2. The processing is carried out, for example, in a 4D processing plane in this processing unit 235, as shown by way of example in area 240 of FIG. 2. An analysis of plant parameter dataset 105 takes place in this 4D processing plane, especially the three-dimensionally detected features of plant 110 with the particular associated points in time as the fourth dimension, so that a very precise inference about the growth or the development of particular plant 115 may be drawn from these pieces of information. In this case, geographic positions 245 stored in plant dataset 165, which are provided, for example, as GPS data of pieces of position information 160 associated with plants 110a and 110b, are linked to data 250 with respect to a history of the development of individual plant(s) 110a and 110b or the re-identification of individual plant(s) 110a and 110b, for example, on the basis of the piece of plant information 140 and/or the pieces of growth information and recognized plant features 255 of particular affected plant 110a and 110b, to be able to ascertain therefrom, for example, the chronological growth of individual plant 110a and 110b, respectively, at the particular associated geographic position. This enables, for example, if the soil condition, the water content of the soil, weather and/or climate data at the geographic position of the field are known, the assessment of the relationship of environmental influences on the growth of the plant of the geographic position to be recognized and in this way, for example, cultivation of seeds to be optimized. It is furthermore conceivable that an annotation 238 takes place on the basis of processing results of the algorithms executed in processing unit 235, in which a change of the data of plant dataset 165 stored in memory unit 155 takes place. In this case, for example, a correction may take place in such a way that upon recognition of a dead plant 110a and 110b, for example, by its being eaten by an animal or due to drought, the piece of plant information for affected plant 110a and 110b contains an additional piece of information that this plant 110a and 110b is no longer to be considered for a further assessment of plants 110 cultivated on the field.

Furthermore, plant dataset 165 may be stored in a database 260, for example, directly in central computer 237, a PC, or a cloud (not shown here). A change of plant dataset 165 which is triggered by database 260 with the aid of a change signal 265 is also conceivable.

Plant dataset 165 or results of a statistical analysis of pieces of information from plant dataset 165 may furthermore be visually displayed in a display unit 265. Results 270 may be ascertained or drawn therefrom, which improve the determination of a seed quality, a particularly favorable method for cultivating seeds, a development of varieties of the plant, a development of the use of plant protection products, etc. A change of plant dataset 165 which is triggered by display unit 265 with the aid of a change signal 275 is also conceivable again here.

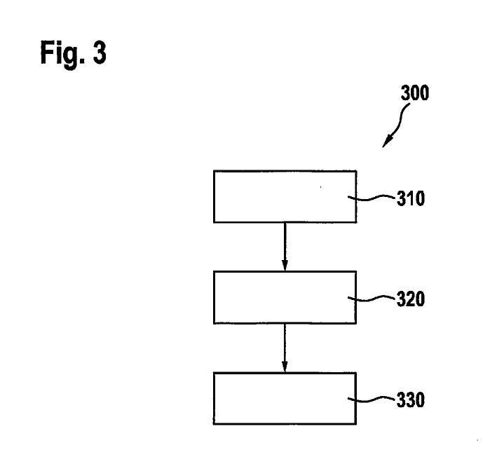

FIG. 3 shows a flow chart of an exemplary embodiment of the approach presented here as method 300 for detecting at least one plant planted on a field. Method 300 includes a step 310 of detecting a plant with the aid of an optical and/or infrared detection unit to obtain a piece of plant image information and detecting a piece of position information, which represents a geographic position at which the plant grows in the field. Furthermore, method 300 includes a step 320 of identifying the plant using the plant image information, to obtain a piece of plant information which represents the presence of the plant. Finally, method 300 includes a step 330 of storing the plant information and the position information in a plant dataset, in order to detect the plant planted on the field.

If an exemplary embodiment includes an “and/or” linkage between a first feature and a second feature, this is to be read to mean that the exemplary embodiment according to one specific embodiment includes both the first feature and the second feature and according to another specific embodiment includes only the first feature or only the second feature.

1-15. (canceled)

16. A method for detecting at least one plant planted on a field, the method comprising:
detecting a plant with an optical and/or infrared detection unit to obtain a piece of plant image information and detecting a piece of position information, which represents a geographic position, at which the plant grows in the field;
identifying the plant using the piece of plant image information, to obtain a piece of plant information, which represents the presence of the plant; and
storing the piece of plant information and the piece of position information in a plant dataset to detect the plant planted on the field.

17. The method of claim 16, wherein, in the detecting, the plant is detected from a plurality of viewing directions and/or using an exposure time of less than one half of a second.

18. The method of claim 16, wherein, in the detecting, the piece of plant image information is detected using a previously read in piece of plant spacing information, which represents a spacing of plants in the field.

19. The method of claim 16, wherein, in the identifying, the plant is identified using a color content of a plant image from the piece of plant image information.

20. The method of claim 16, wherein, in the identifying, a determination of a piece of growth information as a partial information of the piece of plant information takes place, the growth information representing a development state and/or a health state of the plant, in the storing, the piece of growth information being stored as a partial information of the piece of plant information in the plant dataset.

21. The method of claim 16, wherein, in the identifying, a detection of a species of the plant takes place, to obtain a piece of plant information.

22. The method of claim 16, wherein, in the detecting, at least one further plant is detected with an optical and/or infrared detection unit, to obtain at least one further piece of plant image information, and at least one further piece of position information is detected, which represents a further geographic position, at which the further plant grows in the field, in the identifying, the further plant being identified using the further piece of plant image information, to obtain a further piece of plant information, which represents the presence of the further plant and in the storing, the further piece of plant information and the further piece of position information being stored in the plant dataset.

23. The method of claim 16, further comprising:
counting plants cultivated on the field using the piece of plant information and the further piece of plant information from the plant dataset.

24. The method of claim 16, wherein the detecting, the identifying, and the storing are repeatedly executed at least once.

25. The method of claim 16, wherein, in the detecting, the piece of plant image information is detected using a piece of information of a piece of plant image information, which was recorded chronologically previously with or is expected, and/or in the identifying, the plant is identified using a piece of identification information which was recorded chronologically previously.

26. The method of claim 16, wherein, in the detecting, a plausibility check is performed of the piece of plant image information using a piece of plausibility check information including a piece of plant image information recorded chronologically previously, to ascertain a functional capability of the detection unit.

27. The method of claim 16, wherein, in the detecting, a detection unit situated on a vehicle and/or on an aircraft is used to detect the plant.

28. An information system for detecting at least one plant planted on a field, comprising:
an information device configured to perform the following:
detecting a plant with an optical and/or infrared detection unit to obtain a piece of plant image information and detecting a piece of position information, which represents a geographic position, at which the plant grows in the field;
identifying the plant using the piece of plant image information, to obtain a piece of plant information, which represents the presence of the plant; and
storing the piece of plant information and the piece of position information in a plant dataset to detect the plant planted on the field.

29. A non-transitory computer readable medium having a computer program, which is executable by a processor, comprising:
a program code arrangement having program code for detecting at least one plant planted on a field, by performing the following:
detecting a plant with an optical and/or infrared detection unit to obtain a piece of plant image information and detecting a piece of position information, which represents a geographic position, at which the plant grows in the field;
identifying the plant using the piece of plant image information, to obtain a piece of plant information, which represents the presence of the plant; and
storing the piece of plant information and the piece of position information in a plant dataset to detect the plant planted on the field.

30. The method of claim 16, wherein, in the detecting, the plant is detected from a plurality of viewing directions and/or using an exposure time of less than one half of a second, in particular the plant being detected using an exposure time of less than one tenth of a second.

31. The method of claim 16, wherein, in the identifying, the plant is identified using a color content of a plant image from the piece of plant image information, in particular using a green color content of the plant image from the piece of plant image information and/or an infrared content of the plant image from the piece of plant image information.

32. The method of claim 16, wherein, in the identifying, a detection of a species of the plant takes place, to obtain a piece of plant information, in particular a differentiation of the species of the plant from a species of another plant taking place during the detection.

33. The method of claim 16, wherein the detecting, the identifying, and the storing are repeatedly executed at least once, in particular are repeatedly executed cyclically, in particular a time parameter additionally being stored in each step of the storing, which represents an ascertainment point in time of the piece of plant information contained in the stored plant dataset.
